(19) United States
(12) Patent Application Publication
(10) Pub. No.: US 2022/0364420 A1
(43) Pub. Date: Nov. 17, 2022

(54) COUPLING AND METHOD OF JOINING A.P.I. STANDARD PIPES FOR THE EXTRACTION OF CRUDE OILS

(71) Applicant: Byron Raúl López Robayo, Quito (EC)

(72) Inventor: Byron Raúl López Robayo, Quito (EC)

(21) Appl. No.: 17/772,732

(22) PCT Filed: Oct. 28, 2019
(86) PCT No.: PCT/IB2019/059236

§ 371 Date: Apr. 28, 2022

(51) Int. Cl. E21B 17/042; E21B 19/16; F16L 15/04

(52) U.S. Cl. CPC E21B 17/042; E21B 19/16; F16L 15/04

(57) ABSTRACT

An improved coupling for joining pipes of characteristics in accordance with API standards provides for the extraction of crude oils from oil wells, whose improved characteristics, according to the new procedure, achieve a hermetic design of the coupling and, more specifically, relate to the improvement of the threading in the joints by means of modern systems for the fabrication thereof in both the pipe terminals of the well and in the joining of the rounded threads, with computerised rnanufactuting systems and with the incorporation of a shoulder located interiorly in the coupling to achieve, first, the elimination of free spaces that might cause turbulence within the coupling, and second, to create a hermetic metal-to-metal closure and additionally a flexible hydrogenated nitrogen seal, located behind the shoulder, ensuring the hermetic nature of the joint.

### FIELD OF THE INVENTION:

The technical field of the present invention relates to couplings used for the union of API (American Petroleum Institute) standard tubes that make up the production tubing in oil wells, as well as the mechanical adjustments of torque and assembly related to them, and which are required as a whole within the mechanical completion of the system, especially, with the elimination of sensitive points of leakage of the production fluid from the interior of the pipes towards the annular space.

### BACKGROUND OF THE STATE OF THE ART:

The production tubing of an oil well is made up of segments of approximately 9,144 m (30 feet) in length, which are joined or coupled together by means of structural and/or mechanical components that provide the link between tubes and/or accessories. These linking components are known as “couplings”, and are made of steel with high-strength metallurgical characteristics capable of withstanding the pressures and corrosion caused by fluids extracted from oil wells.

More than 90% of the failures suffered by oil extraction pipe strings originate in the couplings, which causes fluids to leak from the production pipe towards the annular space, and, as a consequence, causes the closure of the well due to low pressure and/or loss of production.

The couplings represent between 10% and 50% of the total cost of the tubular section of the mechanical completion, which is highly significant in the production of a well.

The coupling of pipes in the oil extraction process is done with couplings that use the API (American Petroleum Institute) standards majorly used in oil extraction systems. The API coupling is an easy-to-utilize threaded coupling. It has a very simple and uncomplicated construction and manufacturing, and has been used for the last 80 years, and is governed by API standards 5B and 5CT.

With this background, it is essential to achieve tightness in the coupling of the pipes in an oil extraction well. However, it is worth mentioning that the type of API coupling is not completely hermetic, which represents a latent risk during well assembly and production. This type of coupling is characterized in that the type of thread used is round and the pitch of the thread up to each half of the coupling has a truncated-conical profile.

As a result of the execution of this type of traditional couplings called “API-EUE couplings”, the sealing system inside the coupling (coupling), presents the following problems:

a) Threaded joints do not always offer an adequate seal against fluid leaks, and therefore, even after greasing using API standard greases for assembling the coupling with the inlet and outlet pipes using the recommended torque, can leave many weak spots; that is, a hermetic seal is not achieved, not even with the application of grease, which means that these assemblies, over time, can be affected by the axial pressures of the fluids extracted from the wells, thus becoming elements sensitive to developing faults between the threads of round threads, with consequent leakage of the fluid from the interior of the pipes towards the annular space.

b) On the other hand, due to the internal configuration of the threaded systems of the coupling and of the pipe terminals (pins), with a truncated-conical section, a space of variable dimension between pipe pins of about 19 mm (0.75 inches) is created after splicing the coupling and the pipe by applying the recommended torque according to the API standards. The space is like a depression that lends itself to turbulence being generated inside the coupling, leading to the development of an environment conducive to corrosion and consequent possible leak points from inside the coupling towards the annular space, through the threads exposed to this action, causing losses in oil production, which are estimated to be between 10 and 15% of total production.

To solve this problem, US patent 5,689,871, granted in November 1997, filed in 1996, proposes a pipe coupling system that includes a modified coupling characterized by having a first configuration that comprises a metal ring inserted on the inside, specifically in the middle of the coupling, which serves as a torque shoulder for a metal-to-metal seal with the pipe terminals; and a second configuration that comprises the application on the inner central part of the coupling, instead of the metal ring, and three seals: two made of Teflon or a similar material (as defined in the cited patent) and disposed at the bases of the coupling, and another made of torlon (registered trademark, but as defined in the cited patent) or similar material, disposed in the middle of the Teflon ones, thus sealing the free space that remains between pipe pins inside the coupling after the assembly is done. Subsequently, the Argentine patent number AR 042323A, corresponding to the French priority application FR 0215541, dated December 9, 2002, proposes, to solve the problem, by using a seal at the pipe terminals received in the coupling, specifically one at the male threaded pipe terminal and one at the terminal of the female threaded space of the coupling, to overcome the resulting problem caused by the free space available between the pipe pins to considerably reduce fluid leaks caused by the effect of turbulence that occur in this space. These solutions are oriented to a saline environment, for marine extraction wells.

Another antecedent of the state of the art is described in utility model patent C CN202176275U - API (American Petroleum Institute) that proposes a conical ring placed inside the coupling to form a metal-metal seal with the threaded surfaces of the coupling in an API type piping. There is also the patent application WO 2018/163829 Al, of Japanese origin, which proposes a different solution that includes a square thread system, and a double box coupling, with a construction quite different from that established in the API standard.

What is proposed by these patents has not yet resolved the problem described, so research in this field continues.

On the other hand, in the state of the art, pipe couplings have been developed in well-known brands, such as Tenaris Blue, for Buttress-type threads, among others, known as premium connections. Premium couplings provide advantages while sealing the connection to guarantee tightness to the passage of well production fluids, achieved with substantial modifications and different from API couplings, consisting of a different type of thread, which changes the round thread of the API coupling to a square thread, and incorporates a seating shoulder in the inner mid-section of the coupling to produce a metal-to-metal seal between the pipe terminals and the seating shoulder.

Couplings known in the oil industry as “Premium with seal”, based on metal-to-metal seals, were developed in the early 1970s for applications where standard integral couplings did not perform optimally due to production fluid leaking into the annulus. Since its development, different types of “Premium” connections have been developed day by day in order to cover the wide range of technical needs. These systems have not been able, until today, to be transferred or used in pipes of API standards, because as they correspond to different study analyses they are not applicable to, both due to the dimensioning of pipes as well as the standards used for threads and coupling systems of API standards, as well as its pipes and dimensions, although this type of API coupling is still widely used in the oil well production sector, due to its ease of application and low costs.

### SUMMARY:

The present invention refers to a coupling based on the consideration of the critical points of the coupling system that have been noted above with the incorporation of a sealing set system, between the coupling and the pipes, which guarantees its hermeticity. At the same time, it eliminates the effect of turbulence, by eliminating the free space created between the threaded terminals (pins) of the pipes, and, as a consequence, eliminating the causes of production fluid leaks towards the annular space, through threads and corrosion in the couplings. The critical points considered for the coupling of the present invention are the following:

a) Improvement of the threading process, both in the pipe terminals and in the coupling, achieved through the use of advanced manufacturing technologies, such as CNC (Computerized Numerical Control) technologies, for an improved metal-to-metal seal between threads of threads, which guarantees tightness;

b) Incorporation of a shoulder in the coupling, for a pressure settlement on the flat annular edges of the same, of the terminals of the pipe (pins) that enter the coupling, forming a second metal-to-metal seal, when subjected to tightening by applying a tightening torque, to achieve a hermetic seal and eliminate turbulence inside the coupling.

c) The use of the appropriate standardized grease with API characteristics, established according to the norms and field studies, which respond, among other characteristics, to the quality of the fluid of the well in which the inserted piping system will be employed.

d) Incorporation of an elastomeric seal ring, such as hydrogenated nitrile (HNBR), capable of largely recovering its initial dimensions and shapes after being deformed by the action of an effort and being released from it, placed in an annular profile in the interior housing made behind the designed sealing shoulder, and that when the pipe is tightened with the coupling using a torque tool produces a hermetic insulation in the assembly between pipe terminals and threads, to avoid any fluid leakage that could occur into the annular space at removal pressures in these couplings.

The coupling of the invention has been tested using all the characteristics of the extraction of an oil well, using, as indicated, pipes with API-EU standards and with API-EUE improved couplings, which are the most widespread in the oil fields, since the systems that have been mentioned as “PREMIUM” are currently, as indicated, used only for different types of threads, such as the square type, and with different manufacturing and application systems that make their application much more expensive in the oil production sector.

### BRIEF DESCRIPTION OF THE DRAWING:

FIG. 1 shows a coupling of the present invention, wherein: (Fig la) illustrates an exterior view of the coupling; (Fig lb) illustrates a sectional view of the coupling; (Fig lb.1) represents a round thread; (Fig lb.2) represents a housing for “O”-ring; (Fig lb.3) represents an inner projection of the coupling; (Fig lb.4) represents sealing shoulder; (Fig.lb.5) represents bevel; (Fig.lb.Di) represents the inner diameter of the coupling; (Fig.lb.Dt) represents the total internal diameter up to the housing of the “O”-ring; and (Fig.lb.x) represents the taper of the thread.

FIG. 2 shows the coupling, along with the pipe terminals, aligned and ready for assembly. The main details of the terminals of the pipes are identified, which are:

(FIG. 2.2) represents an accommodation for “O” — ring; (FIG. 2.6) represents a machined surface on pipe terminal for metal-to-metal seal; (FIG. 2.7) represents a pipe terminal; (FIG. 2.8) represents a round thread; (FIG. 2.9) represents an “O” — ring; (FIG. 2.Di) represents the inside diameter of pipe; (FIG. 2.Ds) represents the pipe terminal seating outside diameter for metal-to-metal seal; and (FIG. 2.“x”) represents a taper.

FIG. 3 shows the assembly of the pipe terminals with the coupling. The following main details are identified:

(FIG. 3.M) represents the metal-to-metal seal between machined surfaces;

(Fig. 3.R) represents the metal-to-metal seal between round coupling threads; and

(FIG. 3.OR) represents the “O”-ring soft seal.

FIG. 4 shows an illustrative example of a coupling of the invention, made for API EU pipes of 88.9 mm (3 ½ inches).

### DETAILED DESCRIPTION OF THE INVENTION:

The production tubing of an oil well is made up of segments of approximately 9,144 m (30 feet) in length, and of depths of around 4,000 m, for operation in oil extraction fields in conditions vertical or horizontal, and is exposed to high internal and external pressures, as well as high corrosion and variable temperatures. The use of these segments is mainly aimed at extracting oil from wells, washing wells, placing cement plugs, injecting acid into wells; run and anchor gaskets, as well as, in some cases, to inject steam and, in general, to other necessary uses in the oil extraction process, whether vertical or horizontal, more or less deep, and at different temperatures and different characteristics. These pipeline segments with API-EU characteristics are coupled together by structural and/or mechanical components, and/or accessories that are known in the language of the specific oil extraction sector, as “couplings” or couplings. The couplings are manufactured from steel materials subject to different corrosion tests and pressures similar to those exerted in the extraction processes, be they axial, tangential, or barometric. The couplings must also withstand the effects of other variables, such as temperatures, applied during tests to verify their functionality. In addition, the present invention must be subject to the standardized design of the API-EU pipes, and whose normal threads, of the round type, are under the API standards, used in a large sector dedicated to oil extraction, and which, as mentioned above, already suffer frequent damage.

The proposed invention complies with the characteristics of the type of material required for its manufacturing, which have been determined through the tests to which it has been subjected under the standards indicated in the API standard, for the case.

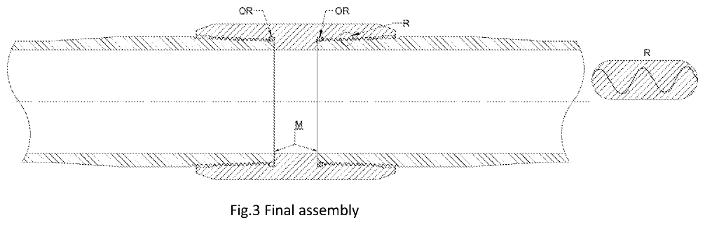

The coupling of the invention is designed, therefore, based on API standards, adhering both to the API-EU pipe and to the characteristics of the original coupling of API-EUE, by maintaining the round thread system but improving the mechanical fit by reducing the variable clearances between the threads in the threads, both of the pipe and the coupling, relying on and using modern manufacturing systems for the male threaded terminals of the pipe, as well as the female threads of the coupling, under API characteristics, but improved with the support of computerized numerical control (CNC) technology for manufacturing, thus obtaining a metal-metal seal between threads (FIG. 3.R), much safer from the point of view of hermeticity than in the current couplings, supplemented by the grease used, which is also standardized according to API standards as types A and C3. In this way, a hermetic seal is obtained, which could be verified during laboratory tests. This better sealing is achieved since there are no differences in curvatures nor are there crests with a great difference between the threads. The male-female fit between the tube and the coupling improves its precision at the time of assembly and tightening by means of torque with a metal-metal seal and also using the API grease to achieve the required tightness.

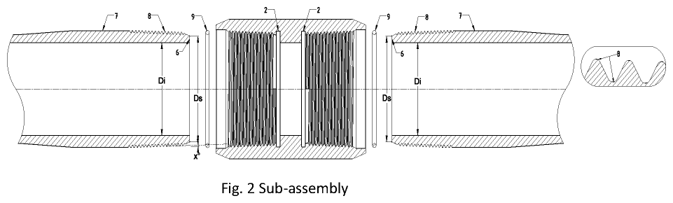

The coupling corresponding to the present invention also incorporates a shoulder (Fig. lb.3) with a straight profile in its internal intermediate part, called sector “2J”, corresponding to the free space between the pipe terminals (FIG. 2.6), and which produces after adjusting the pipes with the recommended torque, a value that will be determined in accordance with each API pipe diameter used and the value of the corresponding torque recommended by the API standard, thus being this axial length corresponding to the length of the shoulder, incorporated into the shoulder of the coupling of the present invention. By occupying this space within the shoulder (Fig. lb.3), the turbulence caused in the space at the time of extraction is eliminated, consequently reducing the chances of corrosion due to this action, and eliminating fluid leaks into the annular space caused by effects of fluid pressure inside the coupling.

The shoulder is made up of a volume of material that is an integral part of the coupling, and which protrudes towards the inside of the coupling in an annular shape (Fig. lb.3), and has the internal diameter (Fig. lb.Di) that corresponds with the internal diameter of the pipe (FIG. 2.Di), being the total diameter at the base of the shoulder (Fig. lb.Dt) that is the one that corresponds to the diameter of the housing (FIG. 2.9) where the flexible seal is placed to incorporate this new coupling. Finally, this shoulder (Fig. lb.3) has a fixed length, known as 2J, for each pipe diameter, which is experimentally determined by applying the tightening torque recommended by the standards.

This straight profile sealing shoulder (FIG. 3.4) is configured to collide with the machined edges of the tube terminals (pins) (FIG. 2.7), which are threaded from both the upper and lower sides of the coupling when assembling the coupling with the set of pipes, by applying the tightening torque in the ranges established by the standard.

An interference is produced between the threaded terminals of the pipes (FIG. 2.6) and the sealing shoulder (FIG. 2.4), to achieve the metal/metal seal (FIG. 3.M), as the main action in the total hermeticity of the set.

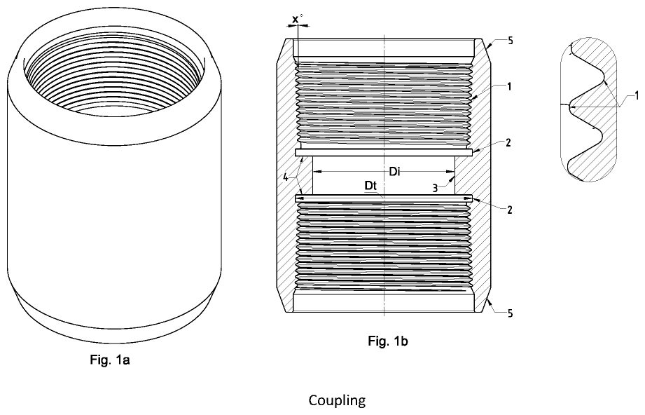

Additionally, the invention comprises annular spaces (FIG. 1b.2 and FIG. 2.9) at operative upper and lower bases of the sealing shoulder, for housing a sealing ring (“O”—ring) (FIG. 3.OR) in each of the operative upper and lower bases of the sealing shoulder, to get an additional hermetic sealing of the coupling. This flexible seal (O-ring) is of hydrogenated nitrile elastomer (HNBR), which, at the time of assembly, is compressed, to fill up the free space, resulting in an additional function to achieve total hermeticity. Due to its flexibility and the characteristics of its components, it recovers its shape after the application of torque, thus reaching and guaranteeing that the seal does not deform and withstands the internal conditions of use, guaranteeing its sealing and maintaining its characteristics, which grant it prolonged use and without damage.

Finally, the coupling of the present invention comprises the creation of chamfers (FIG. 1b.5) with the aim of eliminating obstacles during the tasks of introducing the assembly in the drilling of the oil well.

In order to define the working parameters and expose the indicated hermeticity results, experimental field tests were carried out as indicated below.

The experimental tests were carried out on API-EU standard pipes with a diameter of 88.9 mm (3.5 inches) and 13.84 kg/m (9.3 lbs/f), by applying a tightening torque of 3389.545 N-m (2,500 lb-ft) in the pipes during the assembly process with the coupling. The results of the tests are presented in this report to clarify the invention and its coupling method, and in no case is the application of the invention to pipes of other dimensions usually used in the oil extraction process under standard characteristics considered limiting as per API and API-EU standards, both for the pipe and for its union through the couplings (coupling).

The tolerances established in the design/manufacturing between the operative upper base and the operative lower base of the coupling of the present invention and the pipe terminals are +/− 67.79 N-m (+/− 50 lb-ft).

Applying the torque provides a tight seal between the assembled male-female threads, as well as tight metal-to-metal contact between the sealing shoulder and the machined surfaces of the threaded pipe terminals.

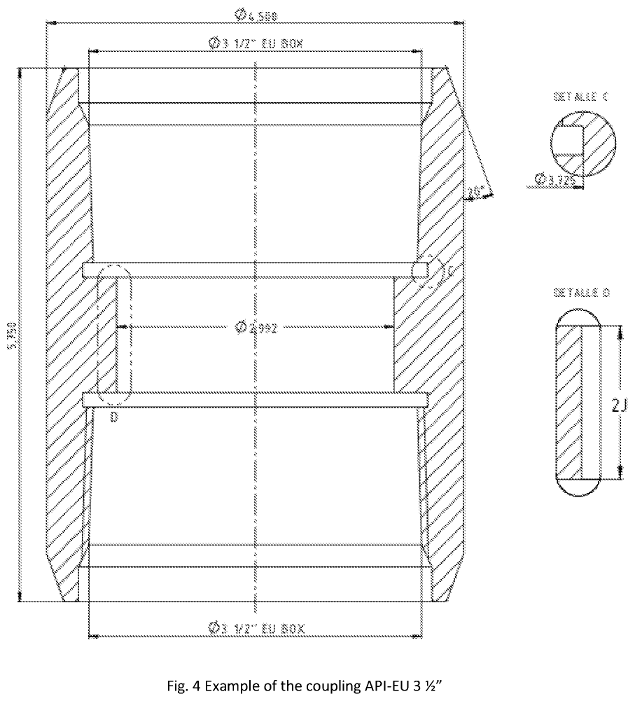

FIG. 4 describes as an example of the embodiment of this invention, a coupling whose design characteristics and dimensions are indicated therein, applied to a pipe of API-EU standards with a diameter of 88.92 mm (3 ½ inches) having also taken into account that the coupling material used is made under the parameters of the established API-EUE standards for the characteristics of the steel used.

To determine the length 2J of the shoulder, the distance between the pipe terminals (pins) is measured after adjustments made using torque. For the example, in this pipe and thread system the value 2J corresponds to a value of 31.5 mm (1.240 inches). The location of the shoulder inside the coupling coaxially in the central part of the coupling is shown in FIG. 4, in which, in addition, it can be seen that by occupying the free space previously existing in said location in traditional API systems, the fluid can continue flowing in the pipe, without variations in diameter, thus avoiding the turbulence that was caused previously. When this element did not exist inside the coupling, corrosion, production fluid leaks towards the annular space and weakening of the exposed walls of the coupling, with possible development of cracks were caused.

The coupling was subjected to hydrostatic pressure, barometric pressure and axial pressure tests. The value of the resistance to collapse was measured for the elements developed in the invention to ensure tightness, caused by yielding collapse, plastic collapse, elastic collapse and transition collapse.

Bursting tests were also developed with the standards established for the API 5C3, 2015 pipe applicable to thin tubes in the threaded terminals.

All these tests were carried out with successful results, including the safety ranges established in the API standard norms.

Table No. 1 below establishes in a comparative manner the main differences between the types of API couplings, the Premium couplings, and those obtained with the present invention:

| | Coupling | Coupling | |
|---|---|---|---|
| | of API | of Present | Premium |
| Characteristics | standards | invention | coupling |
| Threading | Round | Round | Square |
| Shoulder | No | Yes, Straight | Yes, Curly |
| | | profile | profile |
| Metal-metal seal | No | Yes | Yes |
| Spare O-ring | No | Yes | No |
| Length of the | NO | 2J. Fixed | Variable |
| shoulder | | | |

The design of this coupling of the present invention provides the following advantages over the couplings currently widely used for pipes with API standards, by achieving total hermeticity due to its new manufacturing method and the incorporation of new elements in this type of coupling, such as the shoulder and the flexible quality soft seal:

Have a better fit in the sealing threads, due to the fact that they are manufactured practically without gaps, as they are made through modern production systems controlled by computer numerical control procedures, which also guarantees greater manufacturing uniformity, facilitating the assembly of the pipe.

The special design of this coupling improves extraction productivity and reduces downtime costs due to them, by eliminating fluid leaks.

The specially designed sealing shoulder increases the resistance in the threaded connection in the centre of the coupling, providing greater robustness to the pipe string in downhole manoeuvres that require tensile and torsion efforts.

Reduces losses due to friction and turbulence to the passage of fluids inside the pipe, as well as other necessary elements that must enter or exit through the pipe, as defined above.

Increases the life time of the mechanical completion, due to its greater robustness and resistance to corrosion, thanks to its design that prevents the sensitive parts of the extraction pipe string coupling from being affected.

The bevel made on the operative upper and lower bases of the coupling facilitates the assembly tasks of the pipe string, since by eliminating cornered edges it eliminates possible obstructions during the assembly tasks of the pipes inside the well.

1. A coupling for joining oil extraction pipes of API and API-EU standards, characterized in that:
a. the coupling is configured to join a pair of pipes with standardized characteristics, of API-EU with round thread, by means of a male threading system for the pipe and a female threading system for the coupling;
b. the inner part of the coupling contains a coaxial shoulder disposed longitudinally and coaxially with respect to the axis of the coupling; and
c. the coupling comprises a pair of seals of hydrolysed nitrogen elastomer material (HNBR) installed in the annular circular housing, in the upper and lower bases of the shoulder.

2. The coupling according to claim 1, characterized in that the threading of the terminals of the pipe and the coupling are of the round type, and are manufactured using CNC (Computerized Numerical Control) technology.

3. The coupling according to claim 1, characterized in that the threads of the lower and upper union thread of the coupling and the threads of the pipes are joined by applying a layer of grease, and further applying tightening torque to form an air-tight metal-metal seal there between.

4. The coupling according to claim 1, characterized in that the shoulder is configured integral to an operative interior portion of the coupling, said shoulder comprises an annular projection in a radial direction thereof, and has a rectangular profile along its longitudinal section, the shoulder is flat on each side thereof in the coaxial direction, and two terminals of the tubes to be joined are seated on an operative upper base and an operative lower base of said shoulder, thereby forming a metal-metal seal without gaps.

5. The coupling according to claim 1, characterized in that the axial length of the shoulder is constant for each dimension of the pipe diameter, and is determined in its design by means of torque tests.

6. The coupling according to claim 1, characterized in that the coupling comprises a flexible seal of hydrogenated nitrogen that, which at the pressure of the tightening torque of the tubes to the coupling, is fixed in that position to form hermeticity without deformations, said seal being contained in a circular annular housing coaxially formed between the operative upper base and the operative lower base of the shoulder.

7. The coupling according to claim 1, characterized in that both the operative upper base and the operative lower base of the shoulder are bevelled.

8. The coupling according to claim 1, characterized in that a hermetic seal of the coupling system is formed by applying torque in the variants indicated for each type of the pipes corresponding to different diameters and according to API standards.

9. The coupling according to claim 1, characterized in that the coupling is of materials with high resistance to corrosion, high pressures and variable temperatures present in the oil extraction process, and is suitable for all the needs of the production process, with pipes of API-EU and API standards.

10. A method of manufacturing and assembling the coupling of claim 1, characterized in that:
a) the threads of the API pipes to be assembled (the male thread) and of the coupling (the female thread) are of the round type, and the threads of the pipes and the coupling are manufactured by means of the computerized numerical control procedure, and are assembled into the coupling on each side with the pipe terminals;
b) the length of the metal-to-metal seal correspond to each pipe diameter, and is determined based on the free distance measured between the pipe terminals inside the coupling, achieved after applying the torque, according to API standards, and when placed coaxially to the pipe, leaving no room for turbulence inside the coupling;
c) the metal-to-metal seal is achieved between the built-in shoulder and the pipe terminals; and
d) soft seals, for reinforcing the tightness, are located behind the terminal of the pipe, between the sealing shoulder and the thread.
